(19) United States
(12) Patent Application Publication
(10) Pub. No.: US 2015/0212238 A1
(43) Pub. Date: Jul. 30, 2015

(54) SCREEN PROTECTION SHEET WITH FUNCTION OF BLUE LIGHT FILTERING

(71) Applicant: BING-CHEN CHANG, Taoyuan City (TW)

(72) Inventor: BING-CHEN CHANG, Taoyuan City (TW)

(21) Appl. No.: 14/165,597

(22) Filed: Jan. 28, 2014

(51) Int. Cl. G02B 1/11; G02B 5/22

(52) U.S. Cl. CPC G02B 1/113; G02B 5/22

(57) ABSTRACT

A screen protection sheet with a function of blue light filtering comprises a PET film (bi-direction extensible polyester film); an anti-glare layer (or a surface hard-coating layer) on an upper surface of the PET film; an adhesive layer on a lower side of the PET film. A blue light filtering layer is installed on an upper side of the anti-glare layer (or the surface hard-coating layer) or between the film and the adhesive layer, or on an upper side of the anti-glare layer (or the surface hard-coating layer) and a second blue light filtering layer is installed between the film and the adhesive layer. The screen protection sheet may also be formed by a PET film; an anti-glare layer on a lower side of the film; an adhesive layer on a lower side of the anti-glare layer; and a blue light filtering layer on an upper side of the film.

### FIELD OF THE INVENTION

The present invention relates to screen protection sheets, and in particular to a screen protection sheet with a function of blue light filtering.

### BACKGROUND OF THE INVENTION

Screens are widely used in many electronic devices, from medical research, over amount of blue light from the screens will cause that the eyes to get the disease of cataract or even macular degeneration. Furthermore, hurt to eyes due to blue light is continuous and accumulated. This is a serious problem and needs to be kept attention.

However, from modern people, not only computers which attract people to keep the eyesight on the screen, but also many newly developed electronic devices, such as tablet computers, intelligent handsets, etc. cause more and more peoples that need to keep the eyesight on the screens of these electronic devices. However, this phenomena cause harms to eye, even induces the many eye diseases.

For anti-scratch or anti-collision, various screens are adhered with protection sheet thereon. Generally theses sheets are transparent so as not to affect images on the screen as well as provide the effects of anti-scratch and anti-collision. However, current used protection sheets on the screen cannot effectively filter blue light.

### SUMMARY OF THE INVENTION

Therefore, to improve the above mentioned defects in the prior art, the present invention provides a screen protection sheet with a function of blue light filtering which comprises a PET film (bi-direction extensible polyester film) being as a substrate; an anti-glare layer (or a surface hard-coating layer) on an upper surface of the PET film; an adhesive layer on a lower side of the PET film; and wherein a blue light filtering layer is installed.

The blue light filtering layer is installed on an upper side of the anti-glare layer (or the surface hard-coating layer) or between the PET film and the adhesive layer, or on an upper side of the anti-glare layer (or the surface hard-coating layer) and a second blue light filtering layer is installed between the PET film and the adhesive layer.

Furthermore, the present invention further provides a screen protection sheet with a function of blue light filtering comprises: a PET film (bi-directional extensible polyester film) being as a substrate; an anti-glare layer installed on a lower side of the PET film; an adhesive layer installed on a lower side of the anti-glare layer; and a blue light filtering layer installed on an upper side of the PET film.

Furthermore, the present invention further provides a screen protection sheet with a function of blue light filtering comprising: a PET film (or glass film) with blue light filtering particles used as a substrate; an anti-glare layer (or surface hard-coating layer) installed on an upper side of the PET film; and an adhesive layer installed on a lower side of the PET film.

The blue light has wave lengths between 400 nm to 530 nm and will not incident into the user's eye to harm the user so as to active the organ cell of the user's eyes to induce the effect of preventing the harms to retina or lens and preventing the diseases of cataract or even macular degeneration. Therefore, the screen protection sheet A of the present invention has multi-effects. The structure of the present invention can be used to screens of different sizes for eye protection.

### BRIEF DESCRIPTION OF THE DRAWING

FIG. 1 shows a first embodiment of the present invention.

FIG. 2 is a second embodiment of the present invention.

FIG. 3 is a third embodiment of the present invention.

FIG. 4 is a fourth embodiment of the present invention.

FIG. 5 is a schematic view showing that the present invention is used to a screen of a tablet computer.

FIG. 6 is a perspective view showing that the present invention is used to a screen of a tablet computer.

FIG. 7 is a schematic view showing that the present invention is used to a screen of a PC.

FIG. 8 is a perspective view showing that the present invention is used to a screen of a notebook computer.

FIG. 9 is a cross sectional view showing the structure of the blue light filtering layer of the present invention.

FIG. 10 shows another embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

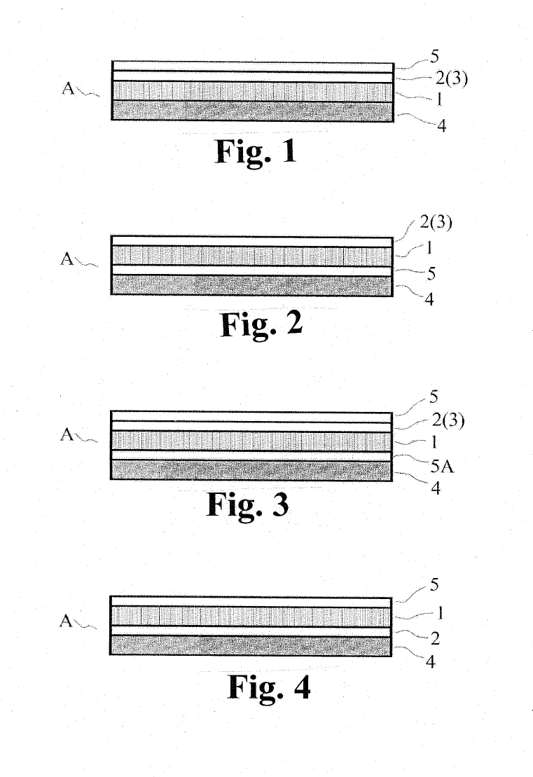

The present invention relates to a blue light screen protection sheet A, with reference to FIG. 1, the present invention comprises:

A PET film 1 (bi-direction extensible polyester film) is as a substrate.

An upper surface of the PET film 1 is installed with an anti-glare layer 2 (AG layer) (or a surface hard-coating layer 3).

A lower side of the PET film 1 is installed with an adhesive layer 4.

Furthermore, as illustrated in FIG. 1, a blue light filtering layer 5 is installed on an upper side of the anti-glare layer 2 (or the surface hard-coating layer 3).

Or as illustrated in FIG. 2, a blue light filtering layer 5 is installed between the PET film 1 and the adhesive layer 4.

Or as illustrated in FIG. 3, a first blue light filtering layer 5 is installed on an upper side of the anti-glare layer 2 (or the surface hard-coating layer 3) and a second blue light filtering layer 5A is installed between the PET film 1 and the adhesive layer 4.

In the present invention, by the screen protection sheet A with a compound structure as above defined, other than the protection effect, the blue light (with wave lengths between 400 nm to 530 nm) is hindered from incident into the user's eye to harm the user so as to active the organ cell of the user's eyes and thus not to harm retina or lens of user's eyes and preventing diseases of cataract or even macular degeneration. Therefore, the screen protection sheet A of the present invention has multi-effects. The structure of the present invention can be used to screens of different sizes for eye protection.

Furthermore, the blue light filtering layer 5 (or 5A) is adhered between the PET film 1 and the adhesive layer 4 by printing, plating, adhesion, coating, and other ways.

With reference to FIG. 4, in the present invention, another structure of the present invention is illustrated. The screen protection sheet A of the present invention illustrated in FIG. 4 comprises:

A PET film 1 (bi-directional extensible polyester film) is as a substrate.

A lower side of the PET film 1 is installed with an anti-glare layer 2.

A lower side of the anti-glare layer 2 is installed with an adhesive layer 4.

An upper side of the PET film 1 is installed with a blue light filtering layer 5.

The blue light filtering layer 5 is installed on the upper side of the PET film 1 by printing, plating, adhesion, coating , and other ways.

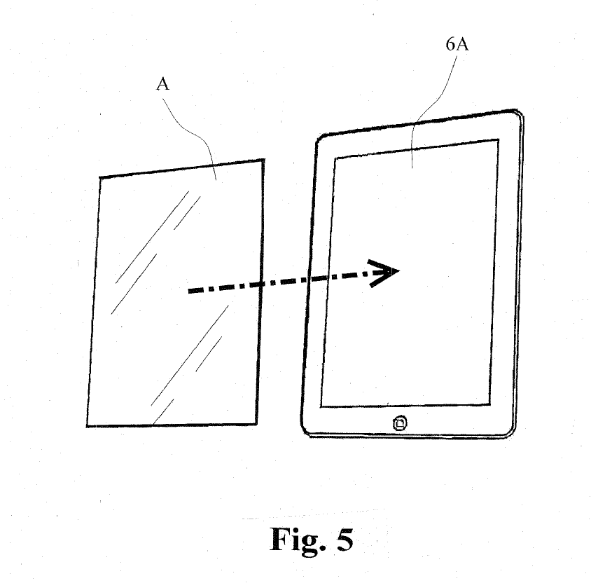

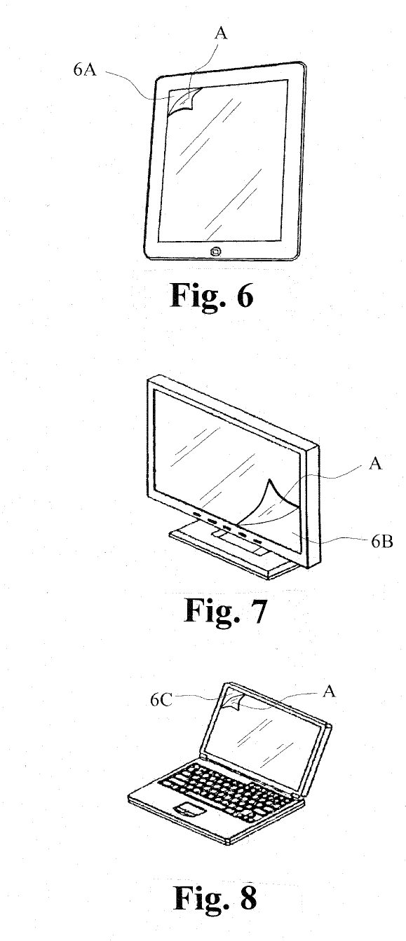

Referring to FIGS. 5 and 6, it is illustrated that the screen protection sheet A of the present invention is adhered to a screen of a tablet computer 6A.

Referring to FIG. 7, it is illustrated that the screen protection sheet A of the present invention is adhered to a screen of a PC 6B.

Referring to FIG. 8, it is illustrated that the screen protection sheet A of the present invention is adhered to a screen of a notebook computer 6C.

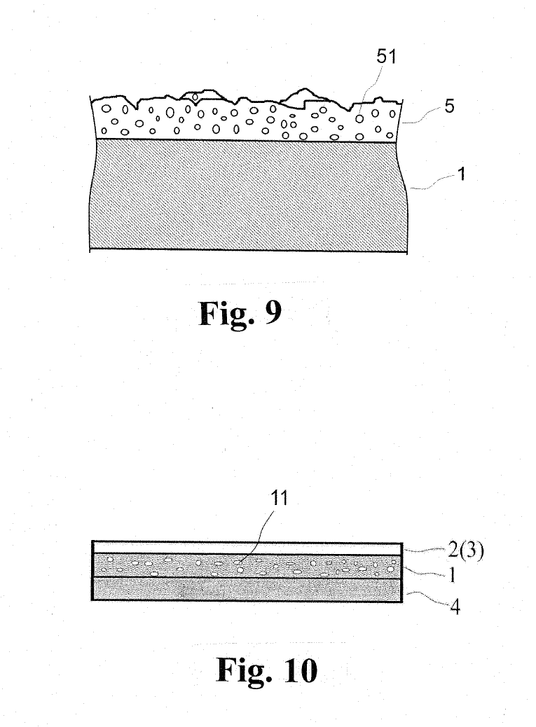

With reference to FIG. 9, in the present invention, the blue light filtering layer 5 is mixed with blue light filtering powders 51 with a size less than one nanometer, a deflection coefficient between 1.3 to 1.8, a weight percent in the blue light filtering layer 5 being between 5% to 40% so as to filter 30 to 45% of incident blue light.

With reference to FIG. 10, furthermore, another structure of the present invention is shown. In FIG. 10, the PET film 1 of the present invention comprises:

A PET film 1 (or glass film) with blue light filtering particles 11 is used as a substrate.

A anti-glare layer 2 (or surface hard-coating layer 3) is installed on an upper side of the PET film 1.

An adhesive layer 4 is installed on a lower side of the PET film 1.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A screen protection sheet with a function of blue light filtering, comprising:
a PET film (bi-direction extensible polyester film) as a substrate;
an anti-glare layer (or a surface hard-coating layer) on an upper surface of the PET film;
an adhesive layer on a lower side of the PET film; and
wherein a blue light filtering layer is installed.

2. The screen protection sheet with a function of blue light filtering as claimed in claim 1, wherein the blue light filtering layer is installed on an upper side of the anti-glare layer (or the surface hard-coating layer).

3. The screen protection sheet with a function of blue light filtering as claimed in claim 1, wherein the blue light filtering layer is installed between the PET film and the adhesive layer.

4. The screen protection sheet with a function of blue light filtering as claimed in claim 1, wherein the first blue light filtering layer is installed on an upper side of the anti-glare layer (or the surface hard-coating layer) and a second blue light filtering layer is installed between the PET film and the adhesive layer.

5. The screen protection sheet with a function of blue light filtering as claimed in claim 1, wherein the blue light filtering layer is installed in the sheet by printing, plating, adhesion, or coating.

6. The screen protection sheet with a function of blue light filtering as claimed in claim 1, wherein the blue light filtering layer is mixed with blue light filtering powders.

7. The screen protection sheet with a function of blue light filtering as claimed in claim 6, wherein the blue light filtering powders have sizes less than one nanometer.

8. The screen protection sheet with a function of blue light filtering as claimed in claim 6, wherein the blue light filtering powders have deflection coefficients between 1.3 to 1.8.

9. The screen protection sheet with a function of blue light filtering as claimed in claim 6, wherein a weight percentage of the blue light filtering powders in the blue light filtering layer is between 5% to 40%.

10. A screen protection sheet with a function of blue light filtering comprises:
a PET film (bi-directional extensible polyester film) as a substrate;
an anti-glare layer installed on a lower side of the PET film;
an adhesive layer installed on a lower side of the anti-glare layer; and
a blue light filtering layer installed on an upper side of the PET film.

11. The screen protection sheet with a function of blue light filtering as claimed in claim 10, wherein the blue light filtering layer is installed by printing, plating, adhesion, or coating.

12. The screen protection sheet with a function of blue light filtering as claimed in claim 10, wherein the blue light filtering layer is mixed with blue light filtering powders.

13. The screen protection sheet with a function of blue light filtering as claimed in claim 12, wherein the blue light filtering powders have sizes less than one nanometer.

14. The screen protection sheet with a function of blue light filtering as claimed in claim 12, wherein the blue light filtering powders have deflection coefficients between 1.3 to 1.8.

15. The screen protection sheet with a function of blue light filtering as claimed in claim 12, wherein a weight percentage of the blue light filtering powders in the blue light filtering layer is between 5% to 40%.

16. A screen protection sheet with a function of blue light filtering comprising:
a PET film (or glass film) with blue light filtering particles used as a substrate;
an anti-glare layer (or surface hard-coating layer) installed on an upper side of the PET film; and
an adhesive layer installed on a lower side of the PET film.
